(19) United States
(12) Patent Application Publication
(10) Pub. No.: US 2008/0061985 A1
(43) Pub. Date: Mar. 13, 2008

(54) Visual display of RFID tag content via laser projection display

(75) Inventor: Martin Strzelczyk, New Market, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/513,391

(22) Filed: Aug. 31, 2006

(51) Int. Cl. G08B 13/14; H04Q 5/22; G08B 3/00

(52) U.S. Cl. 340/572.8; 340/691.6; 340/10.5

(57) ABSTRACT

The present invention is directed to a device and method for displaying content of a radio frequency identification (RFID) tag. The device includes an RFID reader, an interface module, and a laser projection display (LPD). The RFID reader sends instructions to and receives data from an RFID tag. The interface module converts the received data into a format for display. The LPD displays information relating to the data received from the RFID tag. The LPD may display the information directly on an item to which the RFID tag is affixed, or it may display the information on a screen diffuser. The information that is displayed may be numerical data stored in the RFID tag, an iconographic representation of an item to which the RFID tag is affixed, a full resolution image of the item to which the RFID tag is affixed, or the like.

### BACKGROUND OF THE INVENTION

1. Field of the Invention

The present invention is generally directed to radio frequency identification tags, and more particularly to displaying information contained in radio frequency identification tags.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored by devices known as “readers.” Readers typically transmit radio frequency signals to which the RFID tags respond. Each RFID tag can store a unique identification number or other identifiable information. The RFID tags respond to the reader by backscatter transmitting their identification numbers or other identifiable information, so that the tags can be identified.

In a typical fixed mount RFID reader, RFID tag information is conveyed in a non-visual (e.g., network) manner. In a typical hand-held RFID reader, RFID tag information may be visually displayed through the use of a liquid crystal display (LCD) panel. Such a hand-held RFID reader typically includes an LCD panel and a memory that stores the content received from an RFID tag. The content, or information relating to the content, is then transferred to the LCD panel to be displayed. To ensure that the display is visible to a user, the LCD panel is typically relatively large compared to other components of the RFID reader. As a result, such RFID readers are typically bulky and cumbersome devices. Furthermore, such RFID readers do not perform well from a durability perspective because the LCD panels can be damaged relatively easily.

Given the foregoing, what is needed is an improved device and method for visually displaying content of an RFID tag. Such a device should be manufactured to be relatively compact. In addition, such a device should perform well from a durability perspective.

### BRIEF SUMMARY OF THE INVENTION

Embodiments of the present invention meet the above-identified needs by providing a device and method for visually displaying the content of an RFID tag via laser projection display (LPD). Such a device may be manufactured to be relatively compact. In addition, such a device may perform well from a durability perspective because it may be manufactured to be relatively compact and it does not include a LCD panel that may be damaged relatively easily.

In accordance with an embodiment of the present invention there is provided a device for displaying content of an RFID tag. The device includes an RFID reader, an interface module, and an LPD. The RFID reader sends instructions to and receives data from the RFID tag. The interface module converts the received data into a format for display. The LPD displays information relating to the data received from the RFID tag. The information may include numerical data contained in the RFID tag, an iconographic representation of an item to which the RFID tag is affixed, a full-resolution image of the item to which the RFID tag is affixed, and/or application specific information (such as assembly instructions for an RFID labeled component).

In accordance with another embodiment of the present invention there is provided a method for displaying content of an RFID tag. First, instructions are sent to and data is received from the RFID tag. Then, information relating to the data received from the RFID tag is displayed using a LPD.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 illustrates an environment where RFID readers communicate with an exemplary population of RFID tags in accordance with an embodiment of the present invention.

FIG. 2 shows a plan view of an example RFID tag in accordance with an embodiment of the present invention.

FIG. 3 illustrates a circuit block diagram of an RFID tag in accordance with an embodiment of the present invention.

FIG. 4 illustrates a circuit block diagram of the architecture of a RFID tag reader in accordance with an embodiment.

FIG. 5A illustrates a block diagram of a monochromatic LPD in accordance with an embodiment of the present invention.

FIG. 5B illustrates a blow-out view of a full-color LPD in accordance with an embodiment of the present invention.

FIG. 6 illustrates a block diagram of a device for displaying information contained in an RFID tag directly on an item to which the RFID tag is affixed, in accordance with an embodiment of the present invention.

FIG. 7 illustrates a block diagram of a device for displaying information contained in an RFID tag onto a radome/screen, in accordance with an embodiment of the present invention.

FIG. 8 depicts a block diagram illustrating a method for displaying information contained in an RFID tag in accordance with an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

Embodiments of the present invention are directed to a device and method for visually displaying content of an RFID tag using an LPD. As described in more detail herein, such a device for visually displaying content of an RFID tag includes an RFID reader and an LPD, and may be included in a point-of-sale (POS) scanner, a displayless device, a wearable computer/scanner, a scanning kiosk, or a similar type of device as would be apparent to a person of ordinary skill in the relevant art(s). Furthermore, such a device for displaying content of an RFID tag allows the content to be displayed without the need for an LCD panel or similar type of display. As a result, such a device can be manufactured to have a form factor (i.e., size and shape) that is unachievable using conventional LCD display devices. Due to these types of form factors, such a device for visually displaying content of an RFID tag may be more rugged and shock-resistance than conventional RFID readers having LCD panels.

It is noted that references in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

As mentioned above, a device in accordance with an embodiment of the present invention includes an RFID reader and an LPD. The RFID tag sends instructions to and receives data from an RFID tag. The LPD displays the information relating to the content of the RFID tag. After describing the RFID and LPD technologies in more detail, embodiments of the present invention are described.

### II. Overview of RFID Technology

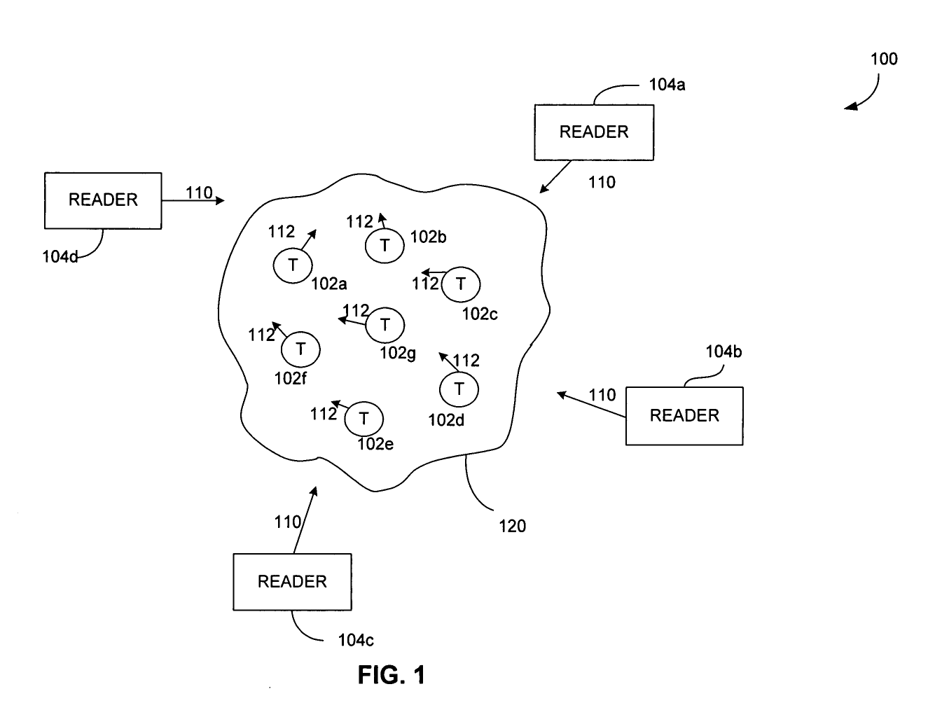

Before describing embodiments of the present invention in detail, it is helpful to describe an example environment in which embodiments of the present invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. According to embodiments of the present invention, a population 120 may include any number of tags 102.

Environment 100 also includes readers 104a-104d. Readers 104 may operate independently or may be coupled together to form a reader network. A reader 104 may be requested by an external application to address the population of tags 120. Alternatively, reader 104 may have internal logic that initiates communication, or may have a trigger mechanism that an operator of reader 104 uses to initiate communication.

As shown in FIG. 1, a reader 104 transmits an interrogation signal 110 having a carrier frequency to the population of tags 120. The reader 104 operates in one or more of the frequency bands allotted for this type of RF communication. For example, frequency bands of 902-928 MHz and 2400-2483.5 MHz have been defined for certain RFID applications by the Federal Communication Commission (FCC). Furthermore, due to regulatory or operational considerations, reader 104 may change carrier frequency on a periodic basis (e.g., ranging from 50 to 400 milliseconds) within the operational band. In these “frequency hopping” systems, the operational band is divided into a plurality of channels. For example, the 902-928 MHz frequency band may be divided into 25 to 50 channels, depending upon the maximum bandwidth defined for each channel. The maximum allowable bandwidth for each channel may be set by local or national regulations. For example, according to FCC Part 15, the maximum allowed bandwidth of a channel in the 902-928 MHz band is 500 kHz. Each channel is approximately centered around a specific frequency, referred to herein as the hopping frequency.

In one embodiment, a frequency hopping reader changes frequencies between hopping frequencies according to a pseudorandom sequence. Each reader 104 typically uses its own pseudorandom sequence. Thus, at any one time, a first reader 104a may be using a different carrier frequency than another reader 104b.

Various types of tags 102 transmit one or more response signals 112 to an interrogating reader 104 in a variety of ways, including by alternatively reflecting and absorbing portions of signal 110 according to a time-based pattern or frequency. This technique for alternatively absorbing and reflecting signal 110 is referred to herein as backscatter modulation. Tags 102 can also use different types of encoding techniques (such as, FM0 and Miller encoding) and modulation techniques (such as, amplitude shift keying and phase shift keying modulation). However, other and more complex encoding and modulation methods (for example, Trellis encoding and quadrature amplitude modulation) may be utilized in embodiments of the present invention. Reader 104 receives response signals 112, and obtains data from response signals 112, such as an identification number of the responding tag 102.

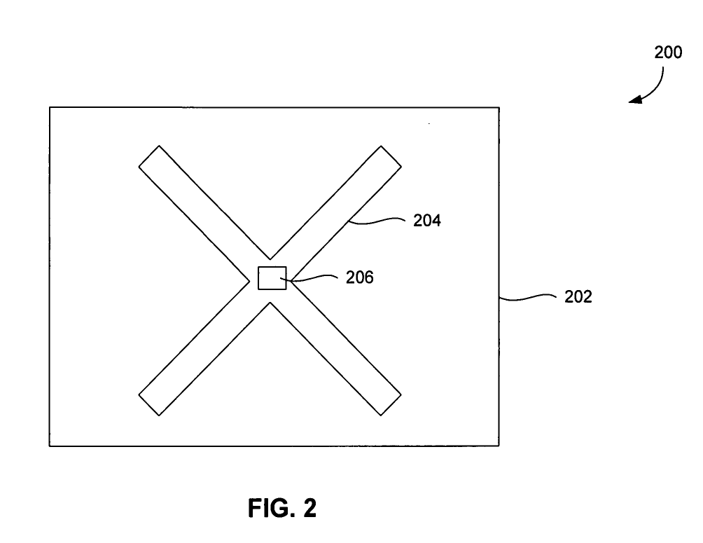

The present invention is applicable to any type of RFID tag. FIG. 2 shows a plan view of an example radio frequency identification (RFID) tag 200. Tag 200 includes a substrate 202, an antenna 204, and an integrated circuit (IC) 206. Antenna 204 is formed on a surface of substrate 202. Antenna 204 may include any number of one or more separate antennas. IC 206 includes one or more integrated circuit chips/dies, and can include other electronic circuitry. IC 206 is attached to substrate 202, and is coupled to antenna 204. IC 206 may be attached to substrate 202 in a recessed and/or non-recessed location. IC 206 controls operation of tag 200, and transmits signals to, and receives signals from RFID readers using antenna 204. Tag 200 may additionally include further elements, including an impedance matching network and/or other circuitry. The present invention is applicable to tag 200 (e.g., a semiconductor type tag), and to other types of tags, including surface wave acoustic (SAW) type tags.

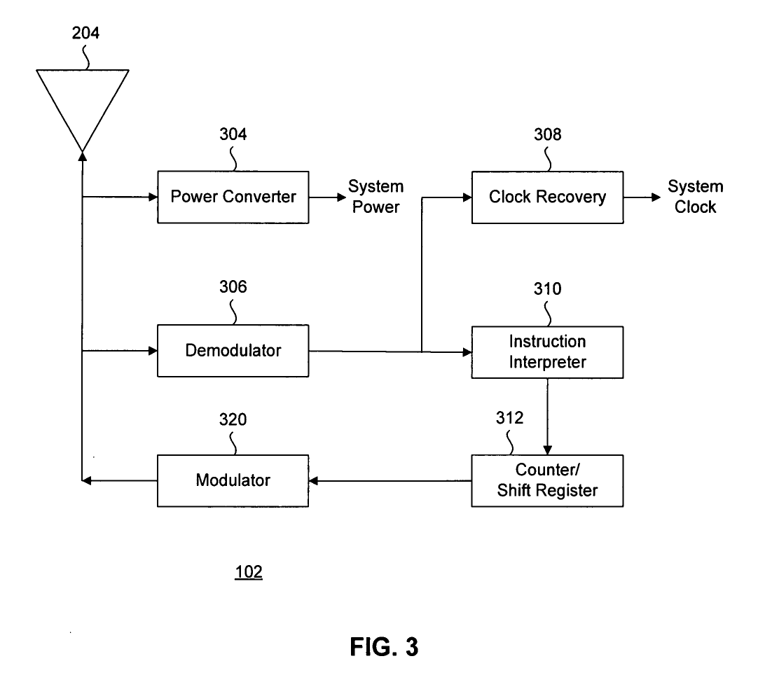

Now the architecture of the tag is described. FIG. 3 is a circuit block diagram of RFID tag 102 according to an embodiment of the present invention. The particular circuit of FIG. 3 is presented by way of example only. Other circuits can be employed without departing from the spirit and scope of the present invention, as would be apparent to one skilled in the relevant art. Tag 102 includes at least one antenna 204, a power converter 304, a demodulator 306, a clock recovery circuit 308, an instruction interpreter 310, a counter/shift register 312, and a modulator 320. In an embodiment, antenna 204 is an omnidirectional antenna, with its impedance matched to the frequency of transmission.

In the depicted embodiment, system power for each tag is provided by a charging signal transmitted by the reader prior to the tag reading operation. Power converter 304 is used to convert the received charging signal to system power. Such power converter circuits are well known in the art. In an embodiment, the charging signal need only be present for a short time to fully charge the tags. In an alternative embodiment (not shown), power converter 304 is replaced by a battery. In that embodiment, the tag reader 104 is not required to transmit a charging signal.

In an alternate embodiment, power controller 304 is augmented by a storage capacitor. In this embodiment, storage capacitor provides a tag with operating power when it is too far away from the reader to be charged by the charging signal. Also, in an alternate embodiment, power converter can be an energy harvester. Energy harvesting involves capturing RF energy in any portion of the RF spectrum and converting the energy into electrical power signals as opposed to information signals. Energy harvesting is well known to persons skilled in the relevant arts. For a tag 102, energy harvesting properties are determined by the characteristics of antenna 204. A fractal antenna is well suited to both energy harvesting and tag 102 operation, and is well known to persons skilled in the relevant arts.

Demodulator 306 receives signals from tag reader 104 via antenna 204. In an embodiment, the received signals comprise a charging signal and one or more instructions. These instructions are described in detail below. One such instruction includes a count instruction that instructs the tags to increment their counter/shift registers 312. In one embodiment, the count instruction causes counter/shift registers 312 to increment by one; in alternative embodiments, the instruction causes counter/shift registers 312 to increment by other values.

In an embodiment, the instructions are transmitted by tag reader 104 using an amplitude-modulated RF signal using a several hundred kilohertz baud rate and a 900 megahertz carrier frequency. Tag reader 104 may vary the bit rate of these transmissions. For example, tag reader 104 may reduce the bit rate if it senses the existence of a noisy RF environment. The instructions are sent by the reader with a “return to center” data format; this format is well-known in the art. The instructions are decoded by tag 102 to generate digital input for instruction interpreter 310 and a system clock. The system clock is recovered by clock recovery circuit 308.

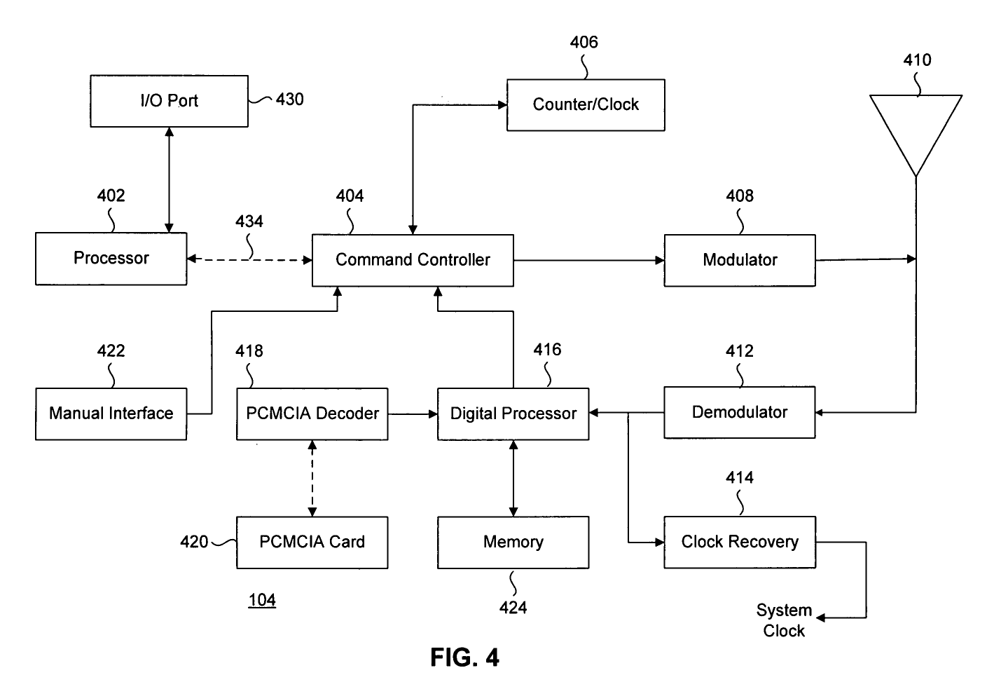

The architecture of tag reader 104 is now described. FIG. 4 is a circuit block diagram of the architecture of tag reader 104 according to an embodiment. The circuitry of tag reader 104 is described in three categories: generic circuitry, processing circuitry, and application-specific circuitry.

Referring to FIG. 4, tag reader processing circuitry is represented by processor 402. Processor 402 performs high level processing functions. These high level functions include compiling inventory lists, handling time slot contentions, coordinating the display of content of an RFID tag received by tag reader 104, and the like, as would be apparent to one skilled in the relevant arts. In an embodiment, processor 402 is coupled to an I/O port 430. In this embodiment, processor 402 coordinates the display of information received from RFID tags by transferring the relevant information to a display device, such as an LPD, that is connected to I/O port 430. The transfer of such information is described in more detail below. Processor 402 may be physically co-located with tag reader 104, or may be physically separate from tag reader 104. The connection 434 between processor 402 and command controller 404 may be hard-wired or wireless.

Application-specific tag reader circuitry is represented by PCMCIA (Personal Computer Memory Card International Association) card 420. In an embodiment, details regarding specific tags, applications, encryption scheme, sensor configuration and data, and modes of operation to be used can be embodied in PCMCIA card 420. In this embodiment, a generic tag reader 104 can be used for multiple inventory applications by merely using different PCMCIA cards.

The remaining circuitry in FIG. 4 comprises tag reader generic circuitry. This is the circuitry used by tag reader 104 to perform generic functions under the control of processor 402 and one or more PCMCIA cards 420. The generic circuitry shown in FIG. 4 is provided for illustrative purposes only, and not limitation. Generic tag reader circuitry includes command controller 404, counter/clock 406, modulator 408, one or more antennas 410, demodulator 412, clock recovery circuit 414, digital processor 416, memory 424, PCMCIA decoder 418, and manual interface 422.

Command controller 404 generates data and instructions under the control of processor 402. These data and instructions are transmitted via modulator 408 and antenna 410 to tags 102. Tag transmissions are received via antenna 410 and demodulator 412 by digital processor 416, which communicates with processor 402 via command controller 404. In an embodiment, digital processor 416 is a physically distinct processor from processor 402. In another embodiment, digital processor 416 is not a separate physical component from processor 402. In this embodiment, digital processor 416 comprises computing processes embodied in processor 402 that parse digital signals received from an RFID tag (such as RFID tags 102). In one embodiment, a system clock may be derived by clock recovery circuit 414 for use in analyzing tag transmissions. The PCMCIA card 420 is coupled to tag reader 104 via a PCMCIA decoder 418. Manual interface 422 provides the operator with control over the tag reader 104.

### III. Overview of LPD Technology

LPD technology is analogous in function to cathode ray tube (CRT) technology, with the electron beam of the CRT technology being replaced by a laser beam in the LPD technology. In LPD, a single visible laser (such as a red laser) is used to produce a monochromatic display. To produce a full color display, three visible lasers are used (such as a red laser, a blue laser, and a green laser). An LPD image may be created via two orthogonally moving mirrors—for example, a high-speed micro-machined mirror and a low-speed micro-machined mirror. Unlike a CRT which requires a vacuum tube and phosphor screen, an LPD image can be projected in free space on any light diffusing surface at any distance. LPD technology is described in more detail, for example, in U.S. Pat. No. 6,655,597, the entirety of which is incorporated by reference herein.

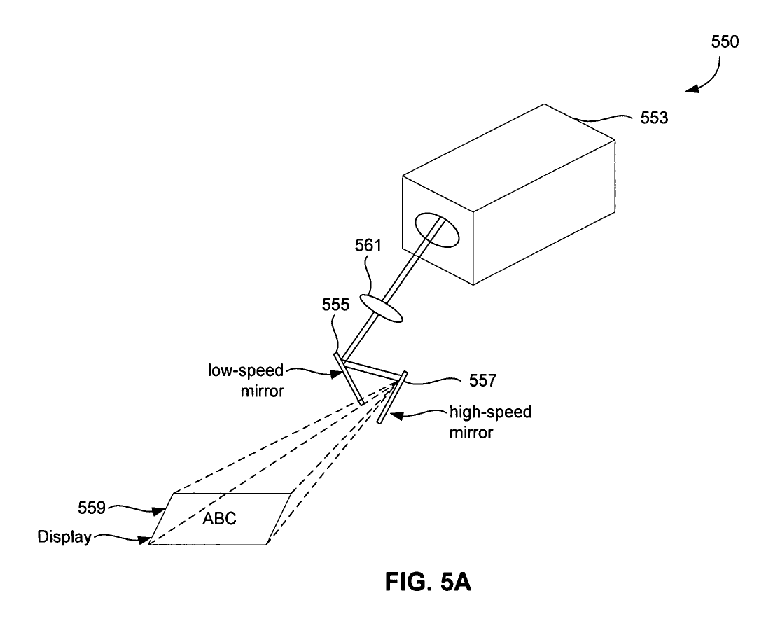

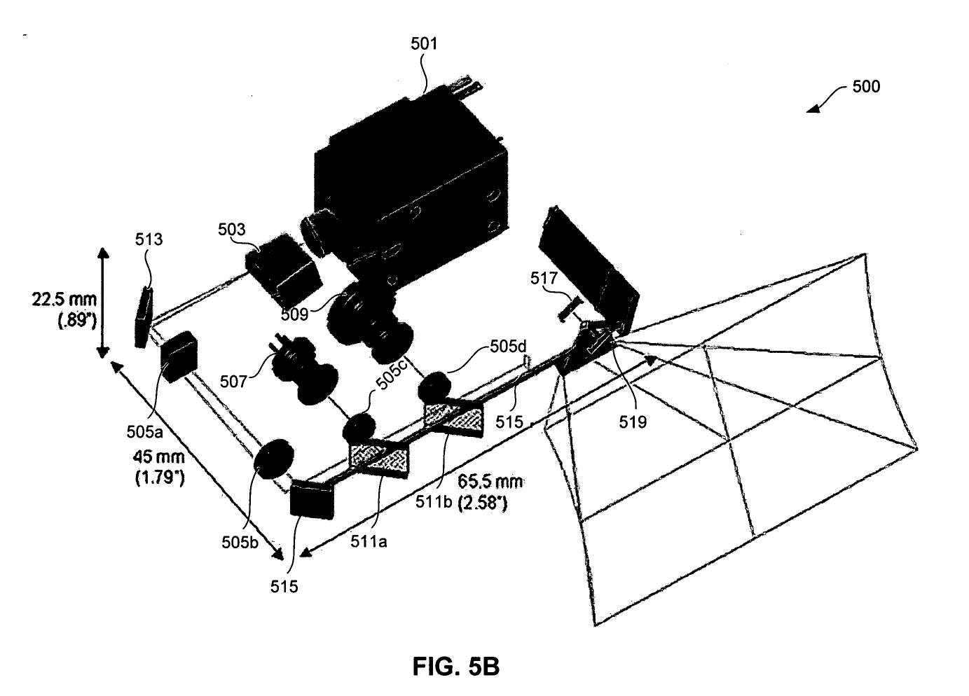

The present invention is applicable to any type of LPD, including a monochromatic LPD. FIG. 5A depicts a block diagram of an example monochromatic LPD 550 in accordance with an embodiment of the present invention. Monochromatic LPD 550 includes a laser 553, a low-speed mirror 555, a high-speed mirror 557, and (optionally) includes a lens 561. Laser 553 may be any type of laser (such as a laser diode, an injection laser diode, a pumped laser diode, or the like) and may be any color (such as red (˜670-650 nm), red-orange (˜635 nm), yellow-orange (˜594 nm), green (˜532 nm), blue (˜473 nm), or some other color). Low-speed mirror 555 and high-speed mirror 557 may be micro-electro-mechanical structures (MEMS) mirrors.

Monochromatic LPD 550 is functional to produce a high-resolution, monochromatic display. Laser 553 provides a beam of monochromatic laser light. The laser light produced by laser 553 may be already focus (for example, if laser 553 is a focused laser diode), or may be focused by lens 561. Low-speed mirror 555 scans the beam in a first direction (such as a vertical direction) and high-speed mirror 557 scans the beam in a second, orthogonal direction (such as a horizontal direction). The laser beam impinges on low-speed mirror 555 first, which scans the beam in the first direction at a first frequency f₁. The fan of beam leaving low-speed mirror 555 is directed toward high-speed mirror 557, which scans the beam in the second, orthogonal direction at a second frequency f₂. First frequency f₁ is generally slower than second frequency f₂. In an embodiment, f₁ is equal to approximately 60 Hz and f₂ is equal to approximately 3.8 kHz.

By scanning the laser beam in two orthogonal directions, monochromatic LPD 550 produces a monochromatic raster pattern 559. Monochromatic raster pattern 559 is formed line-by-line similar to a CRT display. To form a first scan line, a spot of focused light from laser 553 is swept by high-speed mirror 557 at second frequency f₂ along the second direction (e.g., horizontal direction). Thereupon, low-speed mirror 555 sweeps the spot at first frequency f₁ along the first direction (e.g., vertical direction). In this way, high-speed mirror 557 may again swept the spot along the second direction forming a second scan line. The formation of successive scan lines proceeds in a similar manner.

An image is created in monochromatic raster pattern 559 by pulsing laser 553 on and off at selected times. Laser 553 produces visible light and is turned on only when a pixel in the desired image is desired to be seen.

Monochromatic LPD 550 may be packaged in a compact casing making it portable and relatively shock-resistant. For example, monochromatic LPD 550 may be included in a casing having dimensions of approximately 10.8 mm×16 mm×28.8 mm.

The present invention is also applicable to full-color LPDs. FIG. 5B depicts a blow-out view of an example full-color LPD 500 in accordance with an embodiment of the present invention. Full-color LPD 500 is a full color projection engine that can project a high quality image on virtually any surface. Full-color LPD 500 includes a red laser 509, a blue laser 507, a green laser 501, focusing lenses 505a-d, a high-speed (X-mirror) 517, and a low-speed (Y-mirror) 519. In an embodiment, red laser 509 produces electromagnetic radiation of approximately 635 nm, blue laser 507 produces electromagnetic radiation of approximately 440 nm, and green laser 501 produces electromagnetic radiation of approximately 532 nm. However, the present invention is not limited to such lasers; other types of lasers may be used without deviating from the spirit and scope of the present invention as would be apparent to a person skilled in the art.

The combination of red laser 509, blue laser 507, and green laser 501 allow full-color LPD 500 to accurately render a wide range of colors. In an embodiment, red laser 509 and blue laser 507 may be semiconductor diodes, which are small in size and operate at low power. Such red and blue laser diodes are commercially available. To modulate the intensity of such red and blue laser diodes, the drive current may be changed. In an embodiment, green laser 501 is a frequency doubled, diode pumped solid-state (DPSS) green laser. In such a DPSS laser, an 808 nm semiconductor laser pumps a yttrium vanadate (Nd:YVO4) crystal, which emits infrared electromagnetic radiation having a wavelength of approximately 1064 nm. An infrared cavity contains a potassium titanium oxide phosphate (KTiOPO₄), or KTP, second harmonic generating (SHG) crystal, which doubles the frequency of the infrared electromagnetic radiation.

The frequency-doubled output of green laser 501 is visible light electromagnetic radiation having a wavelength of approximately 532 nm. An external acousto-optic modulator (AOM) 503 is used because the modulation speed of the solid state laser is relatively slow. The DPSS green laser system, including green laser 501 and AOM 503, accounts for more than approximately half of the 5 watts of power used to run full-color LPD 500 because the temperature of the DPSS green laser system is precisely controlled and the DPSS green laser system is typically on during operation of full-color LPD 500.

Full-color LPD 500 is functional to produce a high-resolution, full-color display. The beams from red laser 509 and blue laser 507 are individually focused by lens 505d and lens 505c, respectively. The beam from green laser 501 is individually focused by lens 505a and lens 505b. The three beams are combined with dichroic optical filters 511a and 511b, and then aligned into a co-linear beam. Low-speed mirror 519 scans the beam 42° in a first direction (such as a vertical direction) at a first frequency f₁ and high-speed mirror 517 scans the beam 56° in a second direction (such as a horizontal direction) at a second frequency f₂. In an embodiment, f₁ is equal to approximately 60 Hz and f₂ is equal to approximately 3.8 kHz. Full-color LPD 500 is capable of displaying XGA resolution images.

The combined laser beam impinges on high-speed mirror 517 first, which scans the beam in the first direction (e.g., horizontal direction). The fan of beams leaving high-speed mirror 517 is directed toward low-speed mirror 519, which scans in the second orthogonal direction (e.g., vertical direction). If the laser beam and the mirror's scan axis are perpendicular to each other, a straight scan line is projected on a flat surface. On the other hand, if there is an angle between the mirror's scanning axis and the incoming laser beam, the scan line follows a curved trajectory when projected on a flat screen. In an embodiment, the beam is perpendicular to the axis of high-speed mirror 517, thereby ensuring straight projection of the lines along the first direction (e.g., horizontal direction). Since the off-center scan lines impinging on low-speed mirror 519 may not be perpendicular to that mirror's scan axis, the length of the projected scan line increases towards the top and bottom edges of the image. This results in a pincushion distortion effect along the second direction (e.g., vertical direction), which is electronically corrected by displaying the scan lines near the top and the bottom of the screen within fewer clock cycles.

By scanning the combined laser beam in two orthogonal directions, full-color LPD 500 produces a full-color raster pattern in a similar manner to that described above with reference to monochromatic LPD 550.

Both low-speed mirror 519 and high-speed mirror 517 generate feedback signals, which allow full-color LPD 500 to control the laser modulation in synch with the correct mirror position. Because high-speed mirror 517 is scanning with a sinusoidal velocity profile at its natural resonance, full-color LPD 500 compensates for the changing speed of the mirror. At scan angles pointing to the left or to the right of the center position, where the scan velocity is lower, the laser beam is turned on for a longer time period and at proportionately lower intensity. This approach ensures that pixel size and intensity remains uniform along the scan line. Near the ends of the scan line, where the mirror stops and changes direction, the lasers are completely turned off.

Example features and performance specifications of full-color LPD 500 are now described. As mentioned above, an LPD may be manufactured to be relatively compact. In an embodiment, the size of full-color LPD 500 is approximately 6.6 cm×4.6 cm×2.3 cm (71 cc or 4.3 cubic inches). The projector can support a variety of optical resolutions, including QVGA, VGA, SGA, XGA, and HDTV 720p. Full-color LPD 500 projects 56° horizontal and 42° vertical maximum scan angles. The average optical output of full-color LPD 500 is approximately 10 lumens, which generates about 60 nits on a 13 inch diagonal screen without optical gain. Typical power consumption of the device is 5 watts. Full-color LPD 500 produces images with 24 bit color depth within a wide color gamut, due to the selection of laser wavelengths at the edges of the visible spectrum (red=635 nm, blue=440 nm, green=532 nm).

The electronics of full-color LPD 500 includes an analog ASIC and a digital ASIC. The analog ASIC controls the laser modulation and mirror oscillations. Full-color LPD 500 also includes an input port (not shown) that receives data to be displayed. The input port may be any type of port for receiving data, including a 24 line parallel data input, a universal serial bus (USB), universal asynchronous receiver transmitter (UART), an inter-integrated circuit (I2C), or another type of input port as would be apparent to a person skilled in the relevant art(s). In an embodiment, the input port mimics an LCD interface. In this way, a standard LCD controller in an end-user device (e.g., RFID reader, mobile phone, or laptop) may send video data directly to full-color LPD 500. The digital ASIC converts the data to accommodate the required internal data structure.

The resolution of full-color LPD 500 depends on the modulation speed of the lasers (e.g., green laser 501, blue laser 507, and red laser 509), the speed of high-speed mirror 517, the size of the laser beam and the scan angle. To achieve XGA resolution, each of the lasers is electronically modulated at a speed greater than approximately 50 MHz. In order to display 768 vertical lines 60 times per second, the horizontal scan rate is greater than approximately 23 kHz, with the LPD displaying lines in both directions. The optical resolution of full-color LPD 500 is limited by diffraction. Since the most restricting aperture in full-color LPD 500 typically is high-speed mirror 517, the maximum mirror size may affect the minimum achievable laser beam size at the projection screen.

In embodiments, LPD 500 can output light of various intensities and can illuminate areas of various sizes. For example, the average power output of full-color LPD 500 is approximately 10 lumens, which is similar to the brightness projected toward the user from a typical LCD laptop screen. However, LCD screens can achieve very good contrast, since ambient light is not reflected from the dark pixels. On the other hand, images projected from full-color LPD 500 on a white surface must compete with reflected ambient light, resulting in lower contrast. In typical office lighting, full-color LPD 500 can project a high contrast image approximately 8 inches in diagonal, and at half lighting, an image of 13 inches diagonal is possible. In a darkened room without ambient light, full-color LPD 500 can project a 50 inch diagonal image. Alternatively, ambient light reducing rear projection screens employing lenticular arrays can be used to improve the contrast of an LPD image, enabling a high contrast 20 inch diagonal display under ambient office lighting.

Full-color LPD 500 can produce an image that is in focus at a wide range of distances. The horizontal resolution is determined by the ratio of the linear extent of the projected line and the spot size. The focusing optics for all three laser beams can maintain this ratio at all distances from the projector, to provide infinite depth of focus. The always-in-focus characteristic of full-color LPD 500 is particularly relevant for mobile applications, where motion is inherent in the user experience and projection surfaces are inconsistent or even curved. Full-color LPD 500 also offers size and cost benefits as compared to conventional projection systems, since it does not require bulky and expensive lenses.

Full-color LPD 500 is capable of withstanding a 1,500 g shock, meaning full-color LPD 500 may be included in a product that can withstand a 4-foot drop to concrete. This feature enables full-color LPD 500 to outperform glass-based LCD screens from a durability perspective.

Monochromatic LPD 550 and/or full-color LPD 500 may also be configured to electro-optically read indicia printed on an object. The indicia may comprise a pattern of bars and spaces (such as a bar code) and/or a one-dimensional or two-dimensional graphics pattern (such as signatures and alphanumeric characters). Devices that electro-optically read indicia printed on an object are well-known to persons skilled in the art, and are described, for example, in U.S. Pat. No. 6,655,597, the entirety of which is incorporated by reference herein.

### IV. An Example Device for Displaying Content of an RFID Tag in Accordance with an Embodiment of the Present Invention

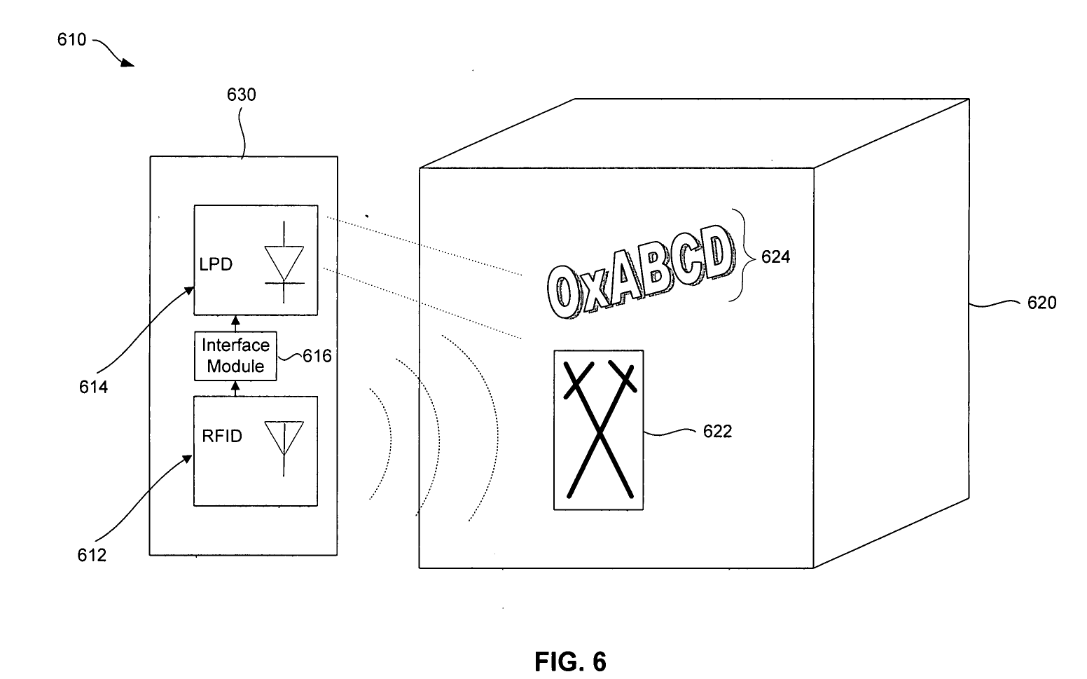

The RFID and LPD technologies described above may be included in a single device for visually displaying content of an RFID tag. FIG. 6 illustrates an example device 610 for visually displaying content of an RFID tag 622 directly onto an item 620 to which RFID tag 622 is affixed. Device 610 includes a housing 630, an RFID reader 612 (similar to RFID reader 104 described above), an LPD 614 (similar to monochromatic LPD 550 or full-color LPD 500 described above), and an interface module 616. RFID tag 622 is similar to RFID tag 102 described above. Housing 630 houses RFID reader 612, LPD 614, and interface module 616.

In operation, RFID reader 104 sends instructions to RFID tag 622 in a similar manner to that described above. RFID tag 622 backscatter transmits identifying information. Data relating to the identifying information transmitted by RFID tag 622 is sent by RFID reader 104 to interface module 616. Interface module 616 converts this data into an appropriate format to be displayed by LPD 614. In an embodiment, interface module 616 converts the data into a format similar to that which would be used to display information on an LCD panel. However, the present invention is not limited to this embodiment. Interface module 616 may convert the data to other formats for display on LPD 614 as would be apparent to a person skilled in the relevant art(s). Interface module 616 may be implemented by software, hardware, firmware, or a combination thereof.

In an embodiment, device 610 may be used in a retail store or warehouse environment to display content of RFID tag 622 affixed to item 620. In this embodiment, device 610 may be carried by a user to be proximate item 620. For example, device 610 may be included in a point-of-sale (POS) scanner, a wearable scanner, or another type of portable scanner as would be apparent to a person skilled in the relevant art(s). RFID reader 612 then sends instructions to RFID tag 622 as described above, and as is well-known in the art. Based on the instructions sent by RFID reader 612, RFID tag 622 backscatter transmits data received by RFID reader 612. The data received by RFID reader 612 is sent as input to LPD 614. LPD 614 may receive the input via a 24 line parallel input, a USB, a UART, or a I2C as described above, or by another port as would be apparent to a person skilled in the relevant art(s). Based on the received input, LPD 614 displays information on item 620 as a raster pattern 624 in a manner similar to that described above with respect to monochromatic LPD 550 and full-color LPD 500. The information displayed on item 620 may be in the form of numerical or alphanumeric data received from RFID tag 622, an iconographic representation of item 620, a full resolution image of item 620, or a similar form of information as would be apparent to a person skilled in the relevant art(s).

In an embodiment, device 610 may store an image (e.g., the numeric, alphanumeric, iconographic, full resolution image, etc.,) to be displayed by LPD 614. In another embodiment, the image to be displayed by LPD 614 is stored in a remote database. In this embodiment, reader 612 reads the tag to retrieve an ID number. The ID is compared to the remote database to locate the image. The item data is transmitted to LPD 614 which can display the image.

By displaying content of RFID tag 622, device 610 may be used in an embodiment to validate external labeling of item 620. In this embodiment, item 620 may include external labeling representative of the internal contents of item 620, and RFID tag 622 may be affixed to the internal content of item 620 and programmed to store data relating to the internal content. To validate the external labeling, the information displayed by device 610 may be compared to the external labeling on item 620 to determine whether the external labeling correctly represents the internal content of item 620. For example, the external labeling of item 620 may comprise text or pictures indicating that the internal content of item 620 includes a television set. In this example, if device 610 displays information on item 620 that indicates that the internal content of item 620 is a television set (e.g., if device 610 displays a full-color image of a television set), then a user may conclude that item 620 is correctly labeled. In this same example, however, if device 610 displays information on item 620 that indicates that the internal content of item 620 is not a television set (e.g., if device 610 displays a full-color image of a digital video recorder), then the user may concluded that item 620 is incorrectly labeled.

As another example, the external labeling of item 620 may comprise indicia, such as a barcode or alphanumeric characters. In this example, device 610 may be configured to electro-optically read the indicia on item 620. Device 610 may be used to validate the external labeling of item 620 using the read indicia in a similar manner to that described above, or in some other manner as would be apparent to a person skilled in the relevant art(s).

As stated above, an LPD device can be incorporated in a relatively small housing compared to a device with an LCD panel. Similarly, device 610 may be incorporated in a housing that is relatively small compared to an RFID reader having an LCD panel. Furthermore, device 610 may outperform an RFID reader having an LCD panel from a durability perspective, as set forth above.

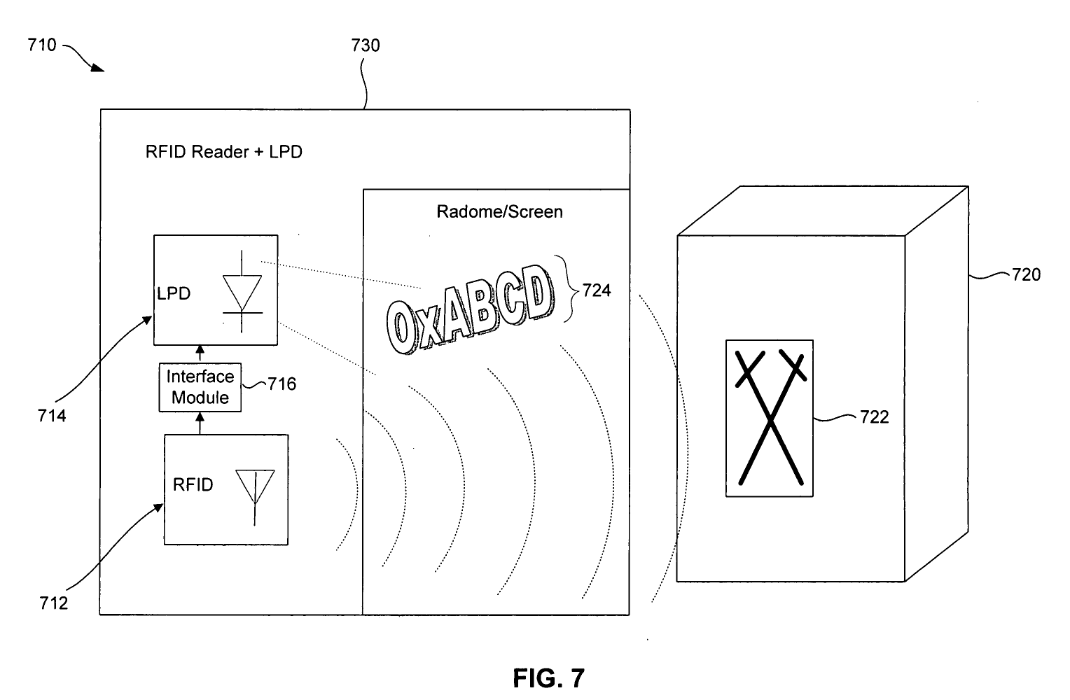

FIG. 7 illustrates an example device 710 that visually displays content of an RFID tag 722 onto a radome/screen of device 710. The radome/screen diffuses the raster pattern so it is visible to a user. Device 710 includes a housing 730, an RFID reader 712 (similar to RFID reader 104 described above), an LPD 714 (similar to monochromatic LPD 550 or full-color LPD 500 described above), and an interface module 716 (similar to interface module 616 described above). RFID tag 722 is similar to RFID tag 102 described above.

In an embodiment, device 710 may be used in a retail store or warehouse environment to display content of RFID tag 722, which is affixed to an item 720. In this embodiment, item 720 may be carried by a user to be proximate device 710. Device 710 functions in a similar manner to device 610 described above, except that a raster pattern 724 produced by device 710 is projected onto a radome/screen. The radome/screen diffuses raster pattern 724 so that the information contained therein is visible to a user. The information may be in the form of numerical data received from RFID tag 722, an iconographic representation of item 720, a full resolution image of item 720, or a similar form of information as would be apparent to a person skilled in the relevant art(s).

Device 710 may be used to validate external labeling of item 720 in a similar manner to that described above with regard to device 610.

### V. An Example Method for Displaying Content of an RFID Tag in Accordance with an Embodiment of the Present Invention

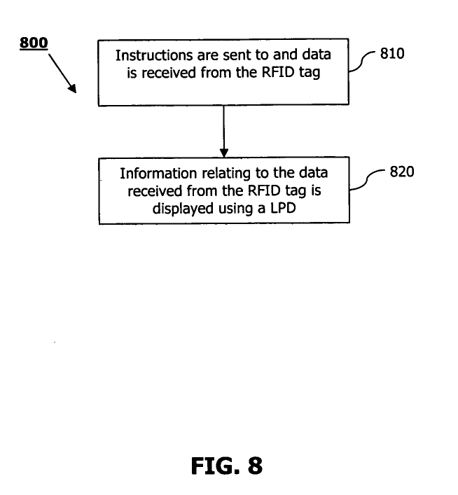

FIG. 8 depicts a block diagram illustrating a method 800 for displaying content of an RFID tag in accordance with an embodiment of the present invention. For example, method 800 may be practiced by using device 610 (described above with reference to FIG. 6) or device 710 (described above with reference to FIG. 7).

Method 800 begins at a step 810 in which instructions are sent to and data is received from an RFID tag. RFID reader 612 or RFID reader 712 may send the instructions to and receive the data from the RFID tag. The RFID tag may be RFID tag 102, RFID tag 622, or RFID tag 722.

In a step 820, information relating to the data received from the RFID tag is displayed using an LPD. The LPD may be LPD 614 or LPD 714. In an embodiment, the information is displayed directly on an item to which the RFID tag is affixed, as described above with reference to FIG. 6. In another embodiment, the information is displayed on a radome/screen, as described above with reference to FIG. 7. The information that is displayed may include numerical data contained in the RFID tag, an iconographic representation of the item to which the RFID tag is affixed, a full-resolution image of the item to which the RFID tag is affixed, and/or application specific information (such as assembly instructions for an RFID labeled component). The information may be obtained in a variety of ways, including those described above. For example, data read from the tag may be used to locate the information to be displayed, which may be stored in the reader or remote database. Alternatively, the data from the tag may be directly displayed. In other words, in an embodiment, the tag stores the text/image, which can be read from the tag, and displayed by the LPD.

### VI. CONCLUSION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What is claimed is:

1. A device for displaying content of a radio frequency identification (RFID) tag, comprising:
an RFID reader that sends instructions to and receives data from the RFID tag;
an interface module that converts the received data into a format for display; and
a laser projection display that displays information relating to the data received from the RFID tag.

2. The device of claim 1, wherein the information is displayed on an item to which the RFID tag is affixed.

3. The device of claim 1, wherein the information is displayed on a screen diffuser.

4. The device of claim 1, wherein the information comprises numerical data received from the RFID tag.

5. The device of claim 1, wherein the information comprises an iconographic representation of an item to which the RFID tag is affixed.

6. The device of claim 1, wherein the information comprises a full resolution image of an item to which the RFID tag is affixed.

7. The device of claim 1, wherein the information comprises application specific information.

8. The device of claim 1, wherein the laser projection display comprises a monochromatic display.

9. The device of claim 1, wherein the laser projection display comprises a color display.

10. The device of claim 1, wherein the laser projection display reads a bar code on an item to which the RFID tag is affixed.

11. The device of claim 1, further comprising:
a housing that houses the RFID reader and the laser projection display.

12. A method for displaying content of a radio frequency identification (RFID) tag, comprising:
sending instructions to and receiving data from the RFID tag using an RFID tag reader; and
displaying information relating to the data received from the RFID tag using a laser projection display.

13. The method of claim 12, wherein the displaying step comprises:
displaying the information on an item to which the RFID tag is affixed.

14. The method of claim 12, wherein the displaying step comprises:
displaying the information on a screen diffuser.

15. The method of claim 12, wherein the displaying step comprises:
displaying information relating to the data received from the RFID tag using a laser projection display, wherein the information comprises numerical data received from the RFID tag.

16. The method of claim 12, wherein the displaying step comprises:
displaying information relating to the data received from the RFID tag using a laser projection display, wherein the information comprises an iconographic representation of an item to which the RFID tag is affixed.

17. The method of claim 12, wherein the displaying step comprises:
displaying information relating to the data received from the RFID tag using a laser projection display, wherein the information comprises a full resolution image of an item to which the RFID tag is affixed.

18. The method of claim 12, wherein the displaying step comprises:
displaying information relating to the data received from the RFID tag using a laser projection display, wherein the information comprises application specific information.

19. The method of claim 12, wherein the displaying step comprises:
displaying information relating to the data received from the RFID tag using a laser projection display, wherein the laser projection display comprises a monochromatic display.

20. The method of claim 12, wherein the displaying step comprises:
displaying information relating to the data received from the RFID tag using a laser projection display, wherein the laser projection display comprises a color display.

21. The method of claim 12, wherein the displaying step comprises:
displaying information relating to the data received from the RFID tag using a laser projection display, wherein the laser projection display reads a bar code on an item to which the RFID tag is affixed.
